(19) United States
(12) Patent Application Publication
(10) Pub. No.: US 2023/0357614 A1
(43) Pub. Date: Nov. 9, 2023

(54) TWO-COMPONENT SOLVENTLESS ADHESIVE COMPOSITIONS AND METHODS OF MAKING SAME

(71) Applicants: Dow Global Technologies LLC, Midland, MI (US); Rohm and Haas Company, Collegeville, PA (US)

(72) Inventors: Rui Shi, Shanghai (CN); Zhaohui Qu, Shanghai (CN); Kaili Wang, Shanghai (CN)

(21) Appl. No.: 18/040,878

(22) PCT Filed: Oct. 22, 2020
(86) PCT No.: PCT/CN2020/122729

§ 371 Date: Feb. 7, 2023

(51) Int. Cl. C09J 175/04; C08G 18/10; C08G 18/28; C08G 18/40

(52) U.S. Cl. CPC C09J 175/04; C08G 18/10; C08G 18/289; C08G 18/4018; C08G 2170/00

(57) ABSTRACT

An adhesive composition is provided. The adhesive composition comprises (A) an isocyanate component comprising an isocyanate prepolymer which comprises the reaction product of at least one isocyanate monomer and at least one polyol selected from the group consisting of a polyester polyol, a polyether polyol and the combination thereof; and (B) a polyol component comprising at least one polyol selected from the group consisting of a polyester polyol, a polyether polyol, and the combination thereof, with the proviso that at least one of (A) and (B) further comprises at least one silane-containing polyol. Also provided are cured adhesive compositions, methods of producing cured laminates, the so produced cured laminates and use of a silane-containing polyol in such adhesive composition.

### FIELD OF THE DISCLOSURE

The present disclosure relates to adhesive compositions. More particularly, the present disclosure relates to two-component solventless adhesive compositions, articles comprising the same and methods of manufacture thereof. The two-component solventless adhesive compositions provide improved performances in terms of, for example, one or more of bonding strength, heat seal performance and chemical resistance.

### BACKGROUND

Adhesive compositions are useful for a wide variety of purposes. For instance, adhesive compositions are used to bond together substrates such as polyethylenes, polypropylenes, polyesters, polyamides, metals, papers, or cellophanes to form composite films, i.e., laminates. The use of adhesives in different laminating end-use applications is generally known. For example, adhesives can be used in the manufacture of film/film and film/foil laminates used in the packaging industry, especially for food packaging. Adhesives used in laminating applications, or “laminating adhesives,” can be generally placed into three categories: solvent-based, water-based, and solventless. The performance of an adhesive varies by category and by the application in which the adhesive is applied.

Solventless laminating adhesives can be applied without either organic solvents or aqueous carriers. Because no organic solvent or water has to be dried from the adhesive upon application, these adhesives can be run at high line speeds and are preferable in applications requiring quick adhesive application. Solvent-based and water-based laminating adhesives are limited by the rate at which the solvent or water carrier can be effectively dried and removed upon application. For environmental, health, and safety reasons, laminating adhesives are preferably aqueous or solventless.

Within the category of solventless laminating adhesives, there are many varieties. One particular variety includes two-component polyurethane-based laminating adhesives. Typically, a two-component polyurethane-based laminating adhesive includes a first component comprising an isocyanate-containing prepolymer and a second component comprising one or more polyols. The two components are combined and applied on a film/foil substrate, which is then laminated to another film/foil substrate.

However, compared to traditional solvent-containing adhesives, the laminations prepared from two-component solventless polyurethane-based laminating adhesives tend to exhibit low bonding strength for foil based lamination structure, poor chemical resistance and heat resistance, and could fail in boiling in bag (BIB) test with Morton soup. It is therefore desirable to develop a two-component solventless polyurethane-based laminating adhesive with improved performances in terms of, for example, one or more of bonding strength, heat seal, and chemical resistance.

### SUMMARY OF THE DISCLOSURE

In an aspect, the present disclosure provides an adhesive composition, comprising:
(A) an isocyanate component comprising an isocyanate prepolymer which comprises the reaction product of at least one isocyanate monomer, at least one polyol selected from the group consisting of a polyester polyol, a polyether polyol and the combination thereof; and
(B) a polyol component comprising at least one polyol selected from the group consisting of a polyester polyol, a polyether polyol, and the combination thereof,
with the proviso that at least one of (A) and (B) further comprises at least one silane-containing polyol.

In a further aspect, the present disclosure provides a cured adhesive composition prepared from the described adhesive composition, comprising the reaction product of a curable mixture of the polyol component and the isocyanate component of the adhesive composition.

In a further aspect, the present disclosure provides a method of producing a cured laminate using the described adhesive composition, comprising:
(a) providing the adhesive composition comprising an isocyanate component and a polyol component;
(b) bringing the isocyanate component and the polyol component into contact, to form a curable mixture;
(c) applying the curable mixture on a first portion of a surface of a substrate to form a layer of the curable mixture;
(d) bringing a second portion of a surface of a substrate into contact with the layer of the curable mixture, so that the layer of the curable mixture is sandwiched between the first portion and the second portion; and
(e) curing the curable mixture or allowing it to cure.

In a further aspect, the present disclosure provides a cured laminate prepared by using the method of producing a cured laminate as described herein.

In a further aspect, the present disclosure provides a cured laminate comprising a first portion of a surface of a substrate, a layer of a cured adhesive composition as described herein, and a second portion of a surface of the same or a different substrate, wherein the layer of the cured adhesive composition is sandwiched between and in contact with the first portion and the second portion.

In a further aspect, the present disclosure provides use of a silane-containing polyol in a two-component polyurethane-based adhesive composition.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

As disclosed herein, all percentages mentioned herein are by weight, and temperatures in ° C., unless specified otherwise.

Adhesive Composition

The adhesive composition according to the present disclosure comprises (A) an isocyanate component and (B) a polyol component.

In some embodiments, the adhesive composition of the present disclosure can be a two-component polyurethane-based adhesive composition. In some embodiments, the adhesive composition according to the present disclosure can be solventless. In some embodiments, the adhesive composition of the present disclosure can be a laminating adhesive composition.

As used herein, the term “solventless” means that the adhesive composition can be applied (for example, up to one hundred percent solids) without either organic solvent or an aqueous carrier. In some embodiments of the present disclosure, the adhesive composition comprises less than 4% by weight, less than 3% by weight, less than 2% by weight, less than 1% by weight, less than 0.5% by weight, less than 0.2% by weight, less than 0.1% by weight, less than 100 ppm by weight, less than 50 ppm by weight, less than 10 ppm by weight, less than 1 ppm by weight of any organic or inorganic solvent or water, or is free of any organic or inorganic solvent or water. Because little or no organic or inorganic solvent or water has to be dried from the adhesive upon application, these adhesives can be run at high line speeds and are preferable in applications requiring quick adhesive application. For environmental, health, and safety reasons, laminating adhesives are preferably solventless.

As used herein, the term “two-component” means that the adhesive composition is provided in parts separated from each other before use. Typically, the composition according to the present disclosure can include at least a first component comprising an isocyanate-containing prepolymer (also referred to herein as an “isocyanate component” or “NCO component”) and a second component comprising one or more polyols (also referred to herein as a “polyol component” or “OH component”). In an illustrative embodiment of the present disclosure, the isocyanate component and the polyol component can be prepared, stored, transported and served separately, combined shortly or immediately before being applied, for example, to a surface of a substrate.

It is contemplated that the isocyanate component and the polyol component of the adhesive composition as described herein can be made separately and, if desired, stored separately until it is desired to use the adhesive composition. When it is desired to use the adhesive composition, the isocyanate component and the polyol component are brought into contact with each other and mixed together. It is contemplated that when these two components are brought into contact, a curing reaction begins in which the isocyanate groups react with the hydroxyl groups to form urethane links. The adhesive composition formed by bringing the two components into contact can be referred to as a “curable mixture.”

In various embodiments of the present disclosure, the isocyanate component can comprise an isocyanate prepolymer. The isocyanate prepolymer can comprise the reaction product of at least one isocyanate monomer, and at least one polyol selected from the group consisting of a polyester polyol, a polyether polyol, and the combination thereof.

In various embodiments of the present disclosure, the polyol component can comprise at least one polyol selected from the group consisting of a polyester polyol, a polyether polyol, and the combination thereof.

In various embodiments of the present disclosure, at least one of the isocyanate component and the polyol component can comprise a silane-containing polyol. In some embodiments, the amount of the silane-containing polyol as described herein in the adhesive composition can be, for example, about 0.5 wt %, about 1.0 wt %, about 1.5 wt %, about 2.0 wt %, about 2.5 wt %, about 3.0 wt %, about 3.5 wt %, about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, about 8.5 wt %, about 9.0 wt %, about 9.5 wt %, about 10.0 wt %, about 10.5 wt %, about 11.0 wt %, about 11.5 wt %, about 12.0 wt %, about 12.5 wt %, about 13.0 wt %, about 13.5 wt %, about 14.0 wt %, about 14.5 wt %, or about 15.0 wt %, or within any range between any two of the aforementioned values, such as from about 0.5 wt % to about 15.0 wt %, from about 0.5 wt % to about 12.0 wt %, from about 0.5 wt % to about 10 wt %, from about 1 wt % to about 12.0 wt %, from about 1 wt % to about 10 wt %, from about 1.5 wt % to about 10 wt %, from about 2 wt % to about 10 wt %, or from about 2.5 wt % to about 10 wt %, based on the total weight of the isocyanate component and the polyol component. In some embodiments, the amount of the silane-containing polyol as described herein in the adhesive composition can be, for example, about 0.5 wt %, about 1.0 wt %, about 1.5 wt %, about 2.0 wt %, about 2.5 wt %, about 3.0 wt %, about 3.5 wt %, about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, about 8.5 wt %, about 9.0 wt %, about 9.5 wt %, about 10.0 wt %, about 10.5 wt %, about 11.0 wt %, about 11.5 wt %, about 12.0 wt %, about 12.5 wt %, about 13.0 wt %, about 13.5 wt %, about 14.0 wt %, about 14.5 wt %, or about 15.0 wt %, or within any range between any two of the aforementioned values, such as from about 0.5 wt % to about 15.0 wt %, from about 0.5 wt % to about 12.0 wt %, from about 0.5 wt % to about 10 wt %, from about 1 wt % to about 12.0 wt %, from about 1 wt % to about 10 wt %, from about 1.5 wt % to about 10 wt %, from about 2 wt % to about 10 wt %, or from about 2.5 wt % to about 10 wt %, based on the weight of the adhesive composition.

In various embodiments of the present disclosure, the NCO/OH ratio of the isocyanate component to the polyol component comprised in the adhesive composition can be within the range of from 0.5:1 to 2.5:1, from 0.8:1 to 2.5:1, from 1:1 to 2.5:1, from 0.5:1 to 2:1, from 0.8:1 to 2:1, from 1:1 to 2:1, from 0.5:1 to 1.8:1, from 0.8:1 to 1.8:1, from 1:1 to 1.8:1, from 0.5:1 to 1.5:1, from 0.8:1 to 1.5:1 or from 1:1 to 1.5:1.

In some embodiments, the weight ratio between the prepolymer in the isocyanate component and the polyol compound(s) in the polyol component can be 1:1 or higher, or 1.2:1 or higher; or 1.5:1 or higher. In some embodiments, the weight ratio between the prepolymer in the isocyanate component and the polyol compound(s) in the polyol component can be 5:1 or lower, or 4.5:1 or lower, or 4:1 or lower. In some embodiments, the weight ratio of between the isocyanate component and the polyol component can be adjusted so that the weight ratio between the prepolymer in the isocyanate component and the polyol compound(s) in the polyol component can be from 100:10 to 100:100, from 100:20 to 100:90, or from 100:30 to 100:80, or can be in the numerical range obtained by combining any two of the following ratios: 100:30, 100:40, 100:45; 100:50, 100:55, 100:60, 100:65, 100:70, 100:75 and 100:80.

The Polyol Component

The polyol component comprised in the adhesive composition according to the present disclosure can comprise at least one polyol. In some embodiments, the polyol component comprised in the adhesive composition can comprise two or more polyols. In some embodiments, the polyol comprised in the polyol component can be selected from the group consisting of a polyester polyol, a polyether polyol, and the combination thereof. In some embodiments, the polyol component can comprise at least one polyester polyol and at least one polyether polyol.

As used herein, the term “polyol” refers to a compound with two or more hydroxyl groups. A polyol with exactly two hydroxyl groups is a “diol.” A polyol with exactly three hydroxyl groups is a “triol.” A polyol with exactly four hydroxyl groups is a “tetraol.”

A compound that contains two or more ester linkages in the same linear chain of atoms is known herein as a “polyester.” A compound that is a polyester and a polyol is known herein as a “polyester polyol.” In some embodiments, the polyester polyols can have a molecular weight not to exceed 10,000 g/mol. In some embodiments, the polyester polyols can have a hydroxyl group functionality of at least 1.5 (i.e., f≥1.5). In some embodiments, the polyester polyols can have a hydroxyl group functionality not to exceed 10 (i.e., f≤10), for example, not to exceed 8, or not to exceed 6.

Polyester polyols suitable for use according to this disclosure include, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or lactones. The polyester polyols can also be derived from, instead of the free polycarboxylic acids, the corresponding polycarboxylic anhydrides, or corresponding polycarboxylic esters of lower alcohols.

Suitable diols include, but are not limited to, ethylene glycol, butylene glycol, diethylene glycol, triethylene glycol, pentylene glycol, hexalene glycol, polyalkylene glycols, such as polyethylene glycol, and also 1,2-propanediol, 1,3-propanediol, 1,3-butanediol, 1,4-butanediol, 1,6-hexanediol, and neopentyl glycol. In order to achieve a polyester polyol functionality greater than 2, polyols having a functionality of 3 can optionally be included in the adhesive composition (e.g., trimethylolpropane, glycerol, erythritol, pentaerythritol, trimethylolbenzene or trishydroxyethyl isocyanurate).

Suitable dicarboxylic acids include, but are not limited to, aliphatic acids, aromatic acids, and combinations thereof. Examples of suitable aromatic acids include phthalic acid, isophthalic acid, terephthalic acid, and tetrahydrophthalic acid. Examples of suitable aliphatic acids include hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, 2,2-dimethyl succinic acid, and trimellitic acid. As used herein, the term “acid” also includes any anhydrides of said acid. Further, monocarboxylic acids, such as benzoic acid and hexane carboxylic acid, should be minimized or excluded from the disclosed compositions. Saturated aliphatic and/or aromatic acids are also suitable for use according to this disclosure, such as adipic acid or isophthalic acid.

In various embodiments, the polyester polyol can have a molecular weight within the numerical range obtained by combining any two of the following end points: 120, 200, 500, 800, 900, 1000, 1200, 1500, 1800, 2000, 2200, 2500, 2800, 3000, 3200, 3500, 3800, 4000, 4200, 4500, 4800, 5000, 5200, 5500, 5800, 6000, 6200, 6500, 6800, 7000, 7200, 7500, 7800, 8000, 8200, 8500, 8800, 9000, 9200, 9500, 9800, and 10000 g/mol.

In some embodiments, one or more of the polyester polyols used in the polyol component can be replaced by one or more polyols selected from the group consisting of polycarbonate polyol, polycaprolactone polyol, other polymers terminated with hydroxyl group, and the combination thereof.

A compound that contains two or more ether linkages in the same linear chain of atoms is known herein as a “polyether.” A compound that is a polyether and a polyol is a “polyether polyol.” In some embodiments, the polyether polyols can have a molecular weight not to exceed 10,000 g/mol. In some embodiments, the polyether polyols can have a hydroxyl group functionality of at least 1.5 (i.e., f≥1.5).

Polyether polyols suitable for use according to this disclosure are the polyaddition products of ethylene oxide, propylene oxide, tetrahydrofuran, butylene oxide, and the co-addition and grafted products thereof, as well as the polyether polyols obtained by condensation of polyhydric alcohols, or mixtures thereof. Examples of polyether polyols suitable for use include, but are not limited to, polypropylene glycol (“PPG”), polyethylene glycol (“PEG”), polybutylene glycol, and polytetramethylene ether glycol (“PTMEG”).

The amount of the polyether polyol in the polyol component can be, by weight based on the weight of the polyol component, at least 0.05 wt %, or at least 10 wt %, at least 20 wt %, or at least 30 wt %. The amount of the polyether polyol in the polyol component is not to exceed, by weight based on the weight of the polyol component, 100 wt %, or 90 wt %, 80 wt % or 70 wt %.

In various embodiments, the polyether polyol can have a molecular weight within the numerical range obtained by combining any two of the following end points: 120, 200, 500, 800, 900, 1000, 1200, 1500, 1800, 2000, 2200, 2500, 2800, 3000, 3200, 3500, 3800, 4000, 4200, 4500, 4800, 5000, 5200, 5500, 5800, 6000, 6200, 6500, 6800, 7000, 7200, 7500, 7800, 8000, 8200, 8500, 8800, 9000, 9200, 9500, 9800, and 10000 g/mol.

In some embodiments, one or more polyester polyols comprised in the polyol component can have a molecular weight less than one or more polyether polyols comprised in the polyol component. In some embodiments, one or more polyester polyols comprised in the polyol component can have a molecular weight 50, 100, 150, 200, 250, 350, 450, 550, 650, 750, 850, 900, 950, 1000, 1100, 1150, 1200, 1300, 1400, 1500, 1600, 1700, 1800 g/mol or more, less than that of one or more polyether polyols comprised in the polyol component. In some embodiments, one or more polyester polyols comprised in the polyol component can have a molecular weight larger than one or more polyether polyols comprised in the polyol component. In some embodiments, one or more polyester polyols comprised in the polyol component can have a molecular weight 50, 100, 150, 200, 250, 350, 450, 550, 650, 750, 850, 900, 950, 1000, 1100, 1150, 1200, 1300, 1400, 1500, 1600, 1700, 1800 g/mol or more, larger than that of one or more polyether polyols comprised in the polyol component.

The polyol component can, optionally, comprise at least one silane-containing polyol, for example, a polyol having a branched silane group. In some embodiments, the at least one silane-containing polyol can be selected from the group consisting of diols, triols, tetraols and the combinations thereof. In some embodiments, the at least one silane-containing polyol can be selected from diols. In some embodiments, the polyol component can be free of any silane-containing polyol. In other embodiments, the polyol component can comprise at least one silane-containing polyol. The silane-containing polyol is described in details herein below.

The polyol component can, optionally, comprise one or more additional auxiliary agents and/or additives for specific purposes.

In some embodiments, the polyol component can, optionally, comprise one or more adhesion promoters to improve bonding strength. Examples of the one or more adhesion promoters suitable for use in the polyol component include, but are not limited to, silane, epoxy and phenolic resin.

In further embodiments, the polyol component can, optionally, comprise one or more chain extenders. Examples of the one or more chain extenders suitable for use in the polyol component include, but are not limited to, glycerin, trimethylol propane, diethylene glycol, propanediol, and 2-methyl-1,3-propanediol.

In still further embodiments, the polyol component can, optionally, comprises one or more catalysts. Examples of the at least one catalyst suitable for use in the polyol component include, but are not limited to, dibutyltin dilaurate, zinc acetate, 2,2-dimorpholinodiethylether, and combinations thereof.

In some embodiments, the polyol component can further comprise one or more auxiliary agents and/or additives selected from the group consisting of other co-catalysts, surfactants, toughening agents, flow modifiers, diluents, stabilizers, plasticizers, catalyst de-activators, dispersing agents and mixtures thereof.

The Isocyanate Component

The isocyanate component comprised in the adhesive composition according to the present disclosure can comprise an isocyanate prepolymer. In some embodiments, the isocyanate prepolymer can comprise the reaction product of reactants comprising at least one isocyanate monomer, and at least one polyol selected from the group consisting of a polyester polyol, a polyether polyol and the combination thereof. In some embodiments, the isocyanate prepolymer can comprise the reaction product of one or more isocyanate monomers and one or more polyols selected from the group consisting of polyester polyols, polyether polyols and the combination thereof.

As used herein, an “isocyanate monomer” is any compound that contains two or more isocyanate groups. An “aromatic isocyanate” is an isocyanate that contains one or more aromatic rings. An “aliphatic isocyanate” contains no aromatic rings.

Isocyanate monomers suitable for use according to the disclosure can be selected from the group consisting of aromatic isocyanates, aliphatic isocyanates, carbodiimide modified isocyanates, and the combinations thereof. Examples of aromatic isocyanates suitable for use according to the disclosure include, but are not limited to, isomers of methylene diphenyl dipolyisocyanate (“MDI”) such as 4,4-MDI, 2,4-MDI and 2,2′-MDI, or modified MDI such as carbodiimide modified MDI or allophanate modified MDI; isomers of toluene-dipolyisocyanate (“TDI”) such as 2,4-TDI, 2,6-TDI, isomers of naphthalene-dipolyisocyanate (“NDI”) such as 1,5-NDI, and the combinations thereof. Examples of aliphatic isocyanates suitable for use according to this disclosure include, but are not limited to, isomers of hexamethylene dipolyisocyanate (“HDI”), isomers of isophorone dipolyisocyanate (“IPDI”), isomers of xylene dipolyisocyanate (“XDI”), isomers of methylene-bis-(4-cyclohexylisocyanate) (“HMDI”), and the combinations thereof. In some embodiments, the isocyanate monomers comprises diisocyanate monomers selected from the group consisting of isophorone diisocyanate (IPDI), methylene-bis-(4-cyclohexylisocyanate) (HMDI), hexamethylene diisocyanate (HDI), methylene diphenyl diisocyanate (MDI), toluene diisocyanate (TDI), and the combination thereof.

The amount of the at least one isocyanate monomer in the isocyanate component is, by weight based on the weight of the isocyanate component, at least 10 wt %, at least 20 wt %, at least 30 wt %, at least 40 wt %, at least 50 wt %, at least 60 wt %. The amount of the at least one isocyanate in the isocyanate component is not to exceed, by weight based on the weight of the isocyanate component, 95 wt %, 90 wt %, 80 wt %, or 70 wt %.

Compounds having isocyanate groups, such as the isocyanate prepolymer of the isocyanate component, may be characterized by the parameter “% NCO,” which is the amount of isocyanate groups by weight based on the weight of the compound. The parameter % NCO is measured by the method of ASTM D 2572-97(2010). The disclosed isocyanate component has a % NCO of at least 3 wt %, or at least 5 wt %, or at least 7 wt %. In some embodiments, the isocyanate component has a % NCO not to exceed 30 wt %, or 25 wt %, or 22 wt %, or 20 wt %.

Suitable examples of polyester polyols are as described above in the polyol component.

In various embodiments, the polyester polyol can have a molecular weight within the numerical range obtained by combining any two of the following end points: 120, 200, 500, 800, 900, 1000, 1200, 1500, 1800, 2000, 2200, 2500, 2800, 3000, 3200, 3500, 3800, 4000, 4200, 4500, 4800, 5000, 5200, 5500, 5800, 6000, 6200, 6500, 6800, 7000, 7200, 7500, 7800, 8000, 8200, 8500, 8800, 9000, 9200, 9500, 9800, and 10000 g/mol.

In some embodiments, one or more of the polyester polyols used in the isocyanate component can be replaced by one or more polyols selected from the group consisting of polycarbonate polyol, polycaprolactone polyol, other polymers terminated with hydroxyl group, and the combination thereof.

Suitable examples of polyether polyols are as described above in the polyol component.

In various embodiments, the polyether polyol can have a molecular weight within the numerical range obtained by combining any two of the following end points: 120, 200, 500, 800, 900, 1000, 1200, 1500, 1800, 2000, 2200, 2500, 2800, 3000, 3200, 3500, 3800, 4000, 4200, 4500, 4800, 5000, 5200, 5500, 5800, 6000, 6200, 6500, 6800, 7000, 7200, 7500, 7800, 8000, 8200, 8500, 8800, 9000, 9200, 9500, 9800, and 10000 g/mol.

In some embodiments, one or more polyester polyols comprised in the isocyanate component can have a molecular weight less than one or more polyether polyols comprised in the isocyanate component. In some embodiments, one or more polyester polyols comprised in the isocyanate component can have a molecular weight 50, 100, 150, 200, 250, 350, 450, 550, 650, 750, 850, 900, 950, 1000, 1100, 1150, 1200, 1300, 1400, 1500, 1600, 1700, 1800 g/mol or more, less than that of one or more polyether polyols comprised in the isocyanate component. In some embodiments, one or more polyester polyols comprised in the isocyanate component can have a molecular weight larger than one or more polyether polyols comprised in the isocyanate component. In some embodiments, one or more polyester polyols comprised in the isocyanate component can have a molecular weight 50, 100, 150, 200, 250, 350, 450, 550, 650, 750, 850, 900, 950, 1000, 1100, 1150, 1200, 1300, 1400, 1500, 1600, 1700, 1800 g/mol or more, larger than that of one or more polyether polyols comprised in the isocyanate component.

The amount of the one or more polyols in the isocyanate component can be, by weight based on the weight of the isocyanate component, at least 5 wt %, at least 10 wt %, at least 15 wt %, at least 20 wt %, at least 25 wt % or at least 30 wt %. The amount of the one or more polyols in the isocyanate component can be not to exceed, by weight based on the weight of the isocyanate component, 60 wt %, 55 wt %, 50 wt %, 45 wt %, or 40 wt %, or 35 wt %.

The isocyanate component can, optionally, comprise at least one silane-containing polyol, for example, a polyol having a branched silane group. In some embodiments, the at least one silane-containing polyol can be selected from the group consisting of diols, triols, tetraols, and the combinations thereof. In some embodiments, the at least one silane-containing polyol can be selected from diols. In some embodiments, the isocyanate component can be free of any silane-containing polyol. In other embodiments, the isocyanate component can comprise at least one silane-containing polyol.

In some embodiments, the silane-containing polyol can be comprised in the isocyanate component to form a mixture with the isocyanate prepolymer. In further embodiments, the silane-containing polyol can be comprised in the isocyanate prepolymer. In some embodiments, the isocyanate component can comprise the reaction product of at least one isocyanate monomer, at least one polyol selected from the group consisting of a polyester polyol, a polyether polyol and the combination thereof, and at least one silane-containing polyol.

The silane-containing polyol is described in details herein below.

The isocyanate component can, optionally, comprise one or more catalysts. Examples of the at least one catalyst suitable for use according to this disclosure include, but are not limited to, dibutyltin dilaurate, zinc acetate, 2,2-dimorpholinodiethylether, and combinations thereof.

In some embodiments, the NCO/OH ratio of the isocyanate component to the polyol component comprised in the adhesive composition can be within the range of from 0.5:1 to 2.5:1, from 0.8:1 to 2.5:1, from 1:1 to 2.5:1, from 0.5:1 to 2:1, from 0.8:1 to 2:1, from 1:1 to 2:1, from 0.5:1 to 1.8:1, from 0.8:1 to 1.8:1, from 1:1 to 1.8:1, from 0.5:1 to 1.5:1, from 0.8:1 to 1.5:1 or from 1:1 to 1.5:1.

Silane-Containing Polyol

In various embodiments of the present disclosure, at least one (e.g., one, two, three or four) saline-containing polyol is comprised in the adhesive composition. In some embodiments, at least one saline-containing polyol is comprised in at least one of the isocyanate component and the polyol component. In some embodiments, one of the polyol component and the isocyanate component of the adhesive composition comprises at least one saline-containing polyol. In some embodiments, each of the polyol component and the isocyanate component of the adhesive composition comprises at least one saline-containing polyol.

In some embodiments, the at least one silane-containing polyol can be selected from the group consisting of silane-containing diols, silane-containing triols, silane-containing tetraols and the combinations thereof. In some embodiments, the at least one silane-containing polyol can be selected from silane-containing diols.

In some embodiments, the silane-containing polyol can be a polyol having a branched silane group. In some embodiments, the silane-containing polyol can comprise a branched silane group which is a silane group represented by the structure —SiR¹₃ wherein each R¹ group independently represents hydrogen, halogen, a C₁ to C₁₂ alkyl, a C₁ to C₁₂ alkoxy, C₃ to C₁₂ cycloalkyl, or a C₂ to C₁₂ alkoxyalkyl which is unsubstituted or substituted with halogen, a C₁ to C₆ alkyl, or a C₁ to C₆ haloalkyl. In some embodiments, at least one R¹ group represents a linear or branched C₁ to C₁₂ alkoxy. In some embodiments, at least two R¹ groups represent independently a linear or branched C₁ to C₁₂ alkoxy. In some embodiments, all of the three R¹ groups represent independently a linear or branched C₁ to C₁₂ alkoxy.

In some embodiments, the silane-containing polyol can have a structure represented by Formula (I):

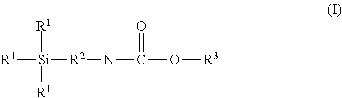

wherein each R¹ independently represents hydrogen, halogen, a C₁ to C₁₂ alkyl, a C₁ to C₁₂ alkoxy, C₃ to C₁₂ cycloalkyl, or a C₂ to C₁₂ alkoxyalkyl which is unsubstituted or substituted with halogen, C₁ to C₆ alkyl, or C₁ to C₆ haloalkyl; R² represents a linear C₁ to C₂₀ alkylene which is unsubstituted or substituted with at least one substituent selected from the group consisting of hydroxyl, halogen, C₁ to C₆ alkyl, C₁ to C₆ alkoxy, C₃ to C₆ cycloalkyl, C₂ to C₆ alkoxyalkyl, and the combinations thereof; R³ represents a linear or branched C₁ to C₁₂ alkyl which is substituted with at least two hydroxyl groups.

In some embodiments, at least one R¹ group represents a linear or branched C₁ to C₁₂ alkoxy. In some embodiments, at least two R¹ groups represent independently a linear or branched C₁ to C₁₂ alkoxy. In some embodiments, all of the three R¹ groups represent independently a linear or branched C₁ to C₁₂ alkoxy.

In some embodiments, R³ represents a linear or branched C₁ to C₁₂ alkyl which is substituted with at least one, two, or three primary hydroxyl groups.

For reasons of clarity, in the context of the present disclosure, “halogen” independently includes fluorine (F), chlorine (Cl), bromine (Br), and iodine (I).

The term “C₁ to C₁₂ alkyl” represents a linear or branched alkyl group containing 1 to 12 carbon atoms, and includes, for example, a methyl group, an ethyl group, a propyl group, a butyl group, a pentyl group, a hexyl group, a heptyl group, an octyl group, a nonyl group, a decyl group, an undecyl group, and a dodecyl group. In some embodiments, the C₁ to C₁₂ alkyl can be, for example, a C₁ to C₈ alkyl, a C₁ to C₆ alkyl, or a C₁ to C₄ alkyl.

The term “C₃ to C₁₂ cycloalkyl” represents a monocyclic or polycyclic cycloalkyl group containing 3 to 12 carbon atoms, and includes, for example, a cyclopropyl group, a cyclobutyl group, a cyclopentyl group, a cyclohexyl group, a cycloheptyl group, a cyclooctyl group, a cyclononyl group, a cyclodecyl group, a cycloundecyl group, a cyclododecyl group, and norbornanyl, etc.

The term “C₂ to C₁₂ alkoxyalkyl” represents a linear or branched alkoxyalkyl group wherein the total number of carbon atoms of the alkoxy moiety and the alkyl moiety is 2 to 12 carbon atoms, and includes, for example, a methoxymethyl group, an ethoxymethyl group, a propyloxymethyl group, an isopropyloxymethyl group, a butyloxymethyl group, an isobutyloxymethyl group, a sec-butyloxymethyl group, a pentyloxymethyl group, a 1-methoxyethyl group, a 2-methoxyethyl group, an 2-ethoxyethyl group, a 2-propyloxyethyl group, an 2-isopropyloxymethyl group, a 2-butyloxymethyl group, a 3-methoxypropyl group, an 3-ethoxypropyl group, a 3-propyloxypropyl group, a 3-methoxybutyl group, an 3-ethoxybutyl group, a 4-methoxybutyl group, an 4-ethoxybutyl group, and a 5-methoxypentyl group, etc. In some embodiments, the C₂ to C₁₂ alkoxyalkyl can be, for example, a C₂ to C₈ alkoxyalkyl, a C₂ to C₆ alkoxyalkyl, a C₂ to C₅ alkoxyalkyl, or a C₂ to C₄ alkoxyalkyl.

The term “C₁ to C₂₀ alkylene” represents a linear or branched saturated carbon chain containing 1 to 12 carbon atoms, and includes, for example, methylene, ethylene, propylene, butylene, pentylene, hexylene, isopropylene, etc.

In a particular embodiment of Formula (I), each R¹ can independently represent hydrogen, halogen, a C₁ to C₈ alkyl, a C₁ to C₈ alkoxy, C₃ to C₆ cycloalkyl, or a C₂ to C₈ alkoxyalkyl. In another particular embodiment of Formula (I), each R¹ can independently represent hydrogen, halogen, a C₁ to C₆ alkyl, a C₁ to C₆ alkoxy, C₃ to C₆ cycloalkyl, or a C₂ to C₆ alkoxyalkyl. In some embodiments, each R¹ can be unsubstituted or substituted with halogen, C₁ to C₆ alkyl (e.g., C₁ to C₅ alkyl, C₁ to C₄ alkyl), or C₁ to C₆ haloalkyl (e.g., C₁ to C₅, or C₁ to C₄ fluoroalkyl, chloroalkyl, or bromoalkyl). In some embodiments, at least one R¹ can represent a C₁ to C₁₂ alkoxy (e.g., a C₁ to C₈ alkoxy, a C₁ to C₆ alkoxy). In some embodiments, at least two R¹ can be the same or different and each represents a C₁ to C₁₂ alkoxy (e.g., a C₁ to C₈ alkoxy, a C₁ to C₆ alkoxy). In some embodiments, at least one R¹ can represent a C₁ to C₁₂ alkyl (e.g., a C₁ to C₈ alkyl, a C₁ to C₆ alkyl). In some embodiments, at least two R¹ can be the same or different and each represents a C₁ to C₁₂ alkyl (e.g., a C₁ to C₈ alkyl, a C₁ to C₆ alkyl). In some embodiments, at least one R¹ can represent a C₂ to C₁₂ alkoxyalkyl (e.g., a C₂ to C₈ alkoxyalkyl, a C₂ to C₆ alkoxyalkyl). In some embodiments, at least two R¹ can be the same or different and each represents a C₂ to C₁₂ alkoxyalkyl (e.g., a C₂ to C₈ alkoxyalkyl, a C₂ to C₆ alkoxyalkyl). In a particular embodiment of Formula (I), each R¹ can independently represent a C₁ to C₁₂ alkoxy. In particular embodiments, each R¹ can be the same or different, and can independently represent a group selected from a methoxy, an ethoxy, a propoxy, a butoxy, a pentyloxy, a hexyloxy, a heptyloxy, an octyloxy, and the combination thereof.

In an embodiment of Formula (I), R² can represent a linear C₁ to C₁₈ alkylene. In another embodiment of Formula (I), R² can represent a linear C₁ to C₁₅ alkylene. In another embodiment of Formula (I), R² can represent a linear C₁ to C₁₂ alkylene. In some embodiments of Formula (I), R² can be unsubstituted or substituted with at least one substituent selected from the group consisting of hydroxyl, halogen, a C₁ to C₆ alkyl (e.g., C₁ to C₅ alkyl, C₁ to C₄ alkyl), a C₁ to C₆ alkoxy (e.g., C₁ to C₅ alkoxy, C₁ to C₄ alkoxy), a C₃ to C₆ cycloalkyl (e.g., C₃ to C₅ cycloalkyl), C₂ to C₆ alkoxyalkyl (e.g., C₂ to C₅ alkoxyalkyl, C₂ to C₄ alkoxyalkyl) and the combinations thereof.

In an embodiment of Formula (I), R³ can represent a linear or branched C₁ to C₁₀ alkyl. In an embodiment of Formula (I), R³ can represent a linear or branched C₁ to C₉ alkyl, C₁ to C₈ alkyl, C₁ to C₇ alkyl, or C₁ to C₆ alkyl. In some embodiments of Formula (I), R³ can be substituted with at least two hydroxyl groups. In some embodiments, R³ can be substituted with at least one, two or three primary hydroxyl groups.

In some exemplary embodiments, the silane-containing polyol can be the reaction product of a silane-containing amine and a carbonate. In some embodiments, the carbonate can be a cyclic carbonate. In particular embodiments, the carbonate can be a 5- to 8-membered ring cyclic carbonate unsubstituted or substituted with hydroxyl or hydroxylalkyl, more preferably hydroxyl or hydroxyl(C₁-C₁₀)alkyl, more preferably hydroxyl or hydroxyl(C₁-C₆)alkyl, still more preferably hydroxyl or hydroxyl(C₁-C₄)alkyl. In some embodiments, the silane-containing amine can have from 5 to 20 carbon atoms. In some embodiments, the silane-containing amine can have from 5 to 16 carbon atoms. In some particular embodiments, the silane-containing amine can be an aminoalkyltrialkyoxysilane, preferably amino(C₁-C₁₀)alkyltri(C₁-C₁₀)alkoxysilane, more preferably amino(C₁-C₆)alkyltri (C₁-C₆)alkoxysilane, still more preferably amino(C₁-C₄)alkyltri(C₁-C₄)alkoxysilane. Examples of suitable aminoalkyltrialkoxysilanes can include aminomethyltrimethoxysilane, aminoethyltrimethoxysilane, aminopropyltrimethoxysilane, aminobutyltrimethoxysilane, aminopentyltrimethoxysilane, aminohexyltrimethoxysilane, aminomethyltriethoxysilane, aminoethyltriethoxysilane, aminopropyltriethoxysilane, aminobutyltriethoxysilane, aminopentyltriethoxysilane, aminohexyltriethoxysilane, aminomethyltripropoxysilane, aminoethyltripropoxysilane, aminopropyltripropoxysilane, aminobutyltripropoxysilane, aminopentyltripropoxysilane, aminohexyltripropoxysilane, aminomethyltributoxysilane, aminoethyltributoxysilane, aminopropyltributoxysilane, aminobutyltributoxysilane, aminopentyltributoxysilane, aminohexyltributoxysilane.

In some embodiments, the amount of the at least one silane-containing polyol in the adhesive composition can be, by weight based on the total weight (for example, total dry weight) of the polyol component and the isocyanate component, at least 0.05 wt %, at least 0.1 wt %, at least 0.3 wt %, at least 0.5 wt %, at least 0.8 wt %, at least 1 wt %, or at least 2 wt %. In some embodiments, the amount of the at least one silane-containing polyol in the adhesive composition can be, by weight based on the total weight (for example, total dry weight) of the polyol component and the isocyanate component, less than 30 wt %, less than 25 wt %, less than 22 wt %, less than 20 wt %, less than 18 wt %, less than 15 wt %, less than 12 wt %, less than 10 wt %, or less than 8 wt %. In some embodiments, the amount of the at least one silane-containing polyol in the adhesive composition can be, by weight based on the total weight (for example, total dry weight) of the polyol component and the isocyanate component, from 0.05 wt % to 30 wt %, from 0.05 wt % to 25 wt %, from 0.3 wt % to 20 wt %, from 0.5 wt % to 18 wt %, from 0.5 wt % to 15 wt %, from 0.5 wt % to 12 wt %, from 0.8 wt % to 18 wt %, from 0.8 wt % to 15 wt %, from 0.8 wt % to 12 wt %, from 1 wt % to 18 wt %, from 1 wt % to 15 wt %, from 1 wt % to 12 wt %, or from 1 wt % to 10 wt %.

Application of the Adhesive Composition

In a further aspect, the present disclosure provides a cured adhesive composition.

In some embodiments, the cured adhesive composition can comprise the reaction product of a curable mixture of the polyol component and the isocyanate component of the adhesive composition as described herein. In some embodiments, the cured adhesive composition can be prepared by bringing the isocyanate component and the polyol component of the adhesive composition as described herein into contact to form a curable mixture, and curing the curable mixture. In some embodiments, the cured adhesive composition can be in the form of a layer. In some embodiments, the cured adhesive composition can be comprised in a laminate.

In a further aspect, the present disclosure provides a method of producing a cured laminate by using the adhesive composition as described herein.

In some embodiments, the method can comprise providing the adhesive composition comprising an isocyanate component and a polyol component as described.

In some embodiments, the method can comprise bringing the isocyanate component and the polyol component into contact, to form a curable mixture. In some embodiments, during the mixing, nitrogen is applied to avoid moisture contamination. In some embodiments, the moisture content of all raw materials is controlled below 500 ppm.

In some embodiments, the method can comprise applying the curable mixture on a first portion of a surface of a substrate (for example, a film) to form a layer of the curable mixture. As used herein, “the first portion of a surface of a substrate” can refer to a part of or the whole surface. In some embodiments, the first portion of a surface can be a part of the surface or the whole surface. In some embodiments, the coating weight of the curable mixture can be from 0.5 to 5.0 g/m², from 0.5 to 4.0 g/m², from 0.5 to 3.0 g/m², from 0.5 to 2.0 g/m², from 0.5 to 1.0 g/m², from 0.8 to 4.0 g/m², from 0.8 to 3.0 g/m², from 1.0 to 3.0 g/m², from 1.5 to 3.0 g/m², or from 1.5 to 2.0 g/m². In some embodiments, the substrate can be made of materials selected from the group consisting of polyethylenes, polypropylenes, polyesters, polyamides, metals, papers, cellophanes and combinations thereof. In some embodiments, the substrate can be in the form of a film.

A “film” can refer to a layer of material having a thickness of 0.5 mm or less. In some embodiments, a film can be a structure that is 0.5 mm or less in one dimension and is 1 cm or more in both of the other two dimensions. In some embodiments, a polymer film is a film that is made of a polymer or mixture of polymers. In some embodiments, the thickness of the layer of the curable mixture applied to the film is 1 to 5 μm. Examples of films can include paper, woven and nonwoven fabric, metal foil, polymers, and metal-coated polymers. Films optionally have a surface on which an image is printed with ink; the ink may be in contact with the adhesive composition. In some embodiments, the films are polymer films and metal-coated polymer films, more preferred are polymer films.

In some embodiments, the method can comprise bringing a second portion of a surface of a substrate (for example, a film) into contact with the layer of the curable mixture, so that the layer of the curable mixture is sandwiched between the first portion and the second portion to form an uncured laminate. As used herein, “a second portion of a surface of a substrate” can refer to a part of or the whole surface. Generally, the second portion is different from the first portion as described above. In some embodiment, the first and second portions can be portions on the same or different surfaces. In some embodiments, the first and second portions can be portions of the same or different surfaces of the same or different substrates. In some embodiments, the first portion of a surface can be part of the surface or the whole surface. In some embodiments, the second portion of a surface can be a part of the surface or the whole surface.

In some embodiments, the uncured laminate can be made at a time when the amount of unreacted polyisocyanate groups present in the adhesive composition is, on a molar basis compared to the amount of polyisocyanate groups present in the isocyanate component prior to contact with the polyol component, at least 50%, or at least 75%, or at least 90%. The uncured laminate can further be made at a time when the amount of unreacted polyisocyanate groups present in the curable mixture is less than 100%, or less than 97%, or less than 95%.

In some embodiments, the method can comprise curing the curable mixture or allowing it to cure. In some embodiments, the uncured laminate may be subjected to pressure, for example, by passing through nip rollers, which may or may not be heated. In some embodiments, the uncured laminate may be heated (for example, at a temperature of from 30° C. to 90° C., for example, from 30° C. to 60° C.) to speed the cure reaction.

In a further aspect, the present disclosure provides a cured laminate, which is prepared by using the method of producing a cured laminate as described herein.

In a further aspect, the present disclosure provides a cured laminate comprising a first portion of a surface of a substrate, a layer of a cured adhesive composition as described herein, and a second portion of a surface of the same or a different substrate, wherein the layer of the cured adhesive composition is sandwiched between and in contact with the first portion and the second portion.

In a further aspect, the present disclosure provides use of the silane-containing polyol compound according to the present disclosure in a two-component polyurethane-based adhesive composition. In some embodiments, the adhesive composition can be solventless. In some embodiments, the silane-containing polyol compound can be comprised in one or both of the hydroxyl component and the isocyanate component of the adhesive composition.

In some embodiments, the silane-containing polyol can be as described above and for example, have a structure represented by Formula (I):

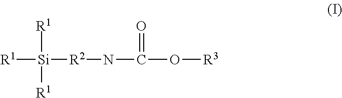

wherein each R¹ independently represents hydrogen, halogen, a C₁ to C₁₂ alkyl, a C₁ to C₁₂ alkoxy, C₃ to C₁₂ cycloalkyl, or a C₂ to C₁₂ alkoxyalkyl which is unsubstituted or substituted with halogen, C₁ to C₆ alkyl, or C₁ to C₆ haloalkyl; R² represents a linear C₁ to C₂₀ alkylene which is unsubstituted or substituted with at least one substituent selected from the group consisting of hydroxyl, halogen, C₁ to C₆ alkyl, C₁ to C₆ alkoxy, C₃ to C₆ cycloalkyl, C₂ to C₆ alkoxyalkyl, and the combinations thereof; R³ represents a linear or branched C₁ to C₁₂ alkyl which is substituted with at least two hydroxyl groups.

### Examples

Some embodiments of the invention will now be described in the following Examples, wherein all parts and percentages are by weight unless otherwise specified. However, the scope of the present disclosure is not, of course, limited to the formulations set forth in these examples. Rather, the Examples are merely inventive of the disclosure.

1. Raw Materials

The information of the raw materials used in the examples is listed in the following Table 1.

TABLE 1
Raw Materials

| Raw Material | Description | Supplier |
|---|---|---|
| ISONATE 50 OP | Liquid MDI | Dow |
| Voranol 1010L | polyether polyol, MW = 1000 | Dow |
| Voranol 2000LM | polyether polyol, MW = 2000 | Dow |
| Bester 648 | polyester polyol, MW = 800 | Dow |
| Voranol CP450 | polyether polyol, MW = 450 | Dow |
| HDO | Hexalene glycol | Sigma |
| JEFFSOL Glycerin Carbonate | Glycerin Carbonate | Huntsman |
| A1100 | Aminopropyltriethoxysilane | Momentive |
| Mor-free 698A* | NCO component of solvent less lamination adhesive | Dow |
| Mor-free C-83** | OH component of solvent less lamination adhesive | Dow |

*Mor-free 698A was used as the NCO component in the solventless lamination adhesive of Comparative Example 2.
**Mor-free C-83 was used as the OH component in the solventless lamination adhesive of Comparative Example 2.

2. Synthesis Procedure

An exemplary polyol with branched silane group according to the present disclosure was synthesized according to the formulation listed in Table 2.

The raw materials JEFFSOL Glycerin Carbonate and A1100 were weighed according to the given formulation and mixed carefully. The mixture was fed into a kettle and the glass reactor was placed in a water bath at a temperature of about 25° C. The mixture was then rotated. The temperature was controlled within a proper range (especially at ambient temperature, generally from 15° C. to 35° C.) and the kettle was under N₂ protection during the whole process. After 72 hours, vacuum (20 mmHg) was applied for 40 minutes at a temperature of about 25° C. The so obtained product was charged into a 100 mL steel bottle with nitrogen protection.

TABLE 2
Formulation of Polyol with branched silane group

| Formulation | Glycerin Carbonate | A1100 |
|---|---|---|
| GC10-3 | 69 g | 114 g |

NCO component and OH-component of the Inventive Examples and Comparative Example were prepared according to the formulations listed in table 3.

NCO-Component:

The NCO component was synthesized in a 1000 mL glass reactor following normal polyurethane pre-polymer preparation process:

Isonate 50 OP was charged into the reactor and kept at 60° C. with nitrogen protection, then the polyols, with or without GC10-3 as indicated in Table 3 were charged into the reactor to mix with MDI. The temperature was increased to 80° C. slowly, and hold for 2 to 3 hours until NCO content met the theoretical value to produce the pre-polymer. Finally, the pre-polymer was charged into a well sealed container with nitrogen protection for further application.

OH-Component:

The OH-component was prepared by mixing the polyols with or without GC10-3 as indicated in Table 3. Before charging the raw materials, moisture content of all raw materials was controlled to be less than 500 ppm. During the whole stirring process, nitrogen was needed for avoiding moisture contamination.

TABLE 3
Two Components Solvent Less Adhesive Formulation (part by weight)

| | | Voranol | Voranol | ISONATE | Bester | | Voranol |
|---|---|---|---|---|---|---|---|
| Formulation | GC10-3 | 2000LM | 1010L | 50 OP | 648 | HDO | CP450 |
| NCO-0 | | | 140 | 340 | 30 | 5 | |
| NCO-1 | 10 | | 140 | 340 | 30 | | |
| NCO-2 | 20 | 140 | | 345 | 30 | | |
| OH-1 | | | | | 55 | | 45 |
| OH-2 | 5 | | | | 55 | | 40 |
| OH-3 | 20 | | | | 50 | | 30 |

Coating and Laminating Process:

Coating and lamination process was conducted in SDC Labo-Combi 400 machine. The nip temperature was kept at 40° C. with 100 m/min speed during the whole lamination process. Coating weight was 1.8-2.0 g/m². Then the laminated film was cured at room temperature (23-25° C.) or in oven before testing.

3. Sample Preparation

The samples were prepared according to the formulations shown in Table 4. The NCO/OH molar ratio of the samples was kept at a level of from 1.0 to 1.8.

TABLE 4
Samples and mix ratios

| | | Mix ratio | Sample |
|---|---|---|---|
| | Sample name | (pbw) | code |
| Comparative Example-1 | NCO-0/OH-1 | 100/60 | C-1 |
| Inventive Example-1 | NCO-1/OH-1 | 100/60 | I-1 |
| Inventive Example-2 | NCO-0/OH-2 | 100/60 | I-2 |
| Inventive Example-3 | NCO-1/OH-2 | 100/60 | I-3 |
| Inventive Example-4 | NCO-2/OH-3 | 100/60 | I-4 |
| Comparative Example-2 | Mor-free 698/C83 | 100/40 | C-2 |

4. Test Methods:

T-Peel (90°) Bonding Strength (Hand Assisted T-Peel)

After curing, the laminated films were cut into 15 mm width strips for T-peel testing in Instron 5943 machine with 250 mm/min crosshead speed. Three strips were tested to take the average value. During the testing, the tail of the strip was pulled slightly by finger to make sure the tail remained 90° degree to the peeling direction

Heat Seal Strength:

The laminates were heat-sealed in a HSG-C Heat-Sealing Machine available from Brugger Company under 140° C. seal temperature and 300N pressure for 1 second, then cooled down and cut into 15 mm width strips for heat seal strength test under 250 mm/min crosshead speed using a 5940 Series Single Column Table Top System available from Instron Corporation. Three strips for each sample were tested and the average value was calculated. Results were in the unit of N/15 mm.

Chemical Resistance (Boil-In-Bag Packed with Morton Soup):

The cured laminating films were cut into 8×12″ size and then folded over to heat seal the bottom and side of the larger rectangle by heat seal machine under 140° C. and 300N/15 mm for 1 second. Then the pouch was filled with Morton soup with ⅔ full, before carefully sealing the top of the pouch in a manner that minimized the air entrapment. In general, Morton soup comprises a mixture of bean oil, ketchup, and vinegar with a 1:1:1 mixing ratio. The heat seal area was kept from being splashed by water, otherwise the heat seal would be poor. Any noticeable preexisting flaws in the heat seal area or laminating area was marked with an indelible marker. Then, the pouches were carefully placed in the boiling water and hold there for 30 min. Make sure the pouches were always immersed in water during the whole boiling process. When completed, the extent of tunneling, delamination, or leakage was recorded, in comparison with the pre-existing flaws. A sample that showed no evidence of tunneling, delamination, or leakage beyond any pre-existing heat seal or laminating flaws would be recorded as “pass”. Then the pouch was opened, emptied and allowed to cool down, then cut into 15 mm width strip to test the T-peel bonding strength and heat seal strength in Instron 5943 machine.

5. Performance Evaluation

The Bond Strength (BS), Heat Seal Strength (HS) and BiB properties are summarized in Table 5. The results show that the inclusion of the silane-containing polyol GC10-3 can significantly improve bonding strength to foil, chemical resistance (good heat seal without tunneling after boil-in-bag test with Morton soup), and hydrolysis stability of the two-component solventless adhesives.

TABLE 5
Performance Results

| Sample Code | | C-1 | I-1 | I-2 | I-3 | I-4 | C-2 |
|---|---|---|---|---|---|---|---|
| GC10-3 Content % | | 0 | 1.2 | 1.9 | 3.1 | 10.49 | 0 |
| BS before BIB | PET/FOIL/PE | 2.12/3.2 | 2.43/5.8 | 2.63/7.8 | 2.75/8.45 | 2.67/8.89 | 2.02/3.5 |
| (N/15 MM) | NY/FOIL/RCPP | 2.42/2.65 | 3.12/6.8 | 3.4/8.6 | 3.69/8.9 | 3.58/9.7 | 1.98/2.32 |
| | NY/PE | 6.66 | 7.88 | 6.35 | 7.6 | 8.2 | 6.5 |
| HS before BIB | PET/FOIL/PE | 32.21 | 38.91 | 40.88 | 41.88 | 45.87 | 42.25 |
| (N/15 MM) | NY/FOIL/RCPP | 43.21 | 47.22 | 43.99 | 44.21 | 50.89 | 42.66 |
| | NY/PE | 45.65 | 46.78 | 49.52 | 51.08 | 52.34 | 50.09 |
| BS after BIB | PET/FOIL/PE | 2.32/1.79 | 2.21/6.5 | 2.78/7.2 | 2.98/8.9 | 3.32/8.99 | 1.04/1.84 |
| (N/15 MM) | NY/FOIL/RCPP | 2.09/1.98 | 2.89/6.4 | 2.92/7.1 | 3.45/9.2 | 3.39/9.23 | 1.62/2.02 |
| | NY/PE | 6.45 | 7.2 | 7.09 | 7.62 | 8.8 | 6.8 |
| HS after BIB | PET/FOIL/PE | 25.65 | 37.54 | 38.21 | 39.08 | 40.23 | 27.22 |
| (N/15 MM) | NY/FOIL/RCPP | 30.21 | 33.21 | 40.11 | 43.02 | 48.92 | 28.98 |
| | NY/PE | 43.22 | 47.22 | 48.47 | 48.76 | 50.65 | 47.55 |
| Appearance | PET/FOIL/PE | Delamination | Good | Good | Good | Good | Delamination |
| after | NY/FOIL/RCPP | Tunneling | Good | Good | Good | Good | Delamination |
| BIB test | NY/PE | Good | Good | Good | Good | Good | Good |

What is claimed is:

1. An adhesive composition, comprising:
(A) an isocyanate component comprising an isocyanate prepolymer which comprises the reaction product of at least one isocyanate monomer, at least one polyol selected from the group consisting of a polyester polyol, a polyether polyol and the combination thereof; and
(B) a polyol component comprising at least one polyol selected from the group consisting of a polyester polyol, a polyether polyol, and the combination thereof,
with the proviso that at least one of (A) and (B) further comprises at least one silane-containing polyol.

2. The adhesive composition according to claim 1, wherein the adhesive composition is solventless.

3. The adhesive composition according to claim 1, wherein the NCO/OH molar ratio of the isocyanate component to the polyol component is within the range of from 0.5:1 to 2.5:1.

4. The adhesive composition according to claim 1, wherein the amount of the at least one silane-containing polyol in the adhesive composition is, by weight based on the total weight of the polyol component and the isocyanate component, at least 0.05 wt %.

5. The adhesive composition according to claim 1, wherein the at least one silane-containing polyol is selected from the group consisting of silane-containing diols, silane-containing triols, silane-containing tetraols and the combinations thereof.

6. The adhesive composition according to claim 1, wherein the at least one silane-containing polyol comprises a branched silane group represented by the structure —SiR¹₃ wherein each R¹ independently represents hydrogen, halogen, a C₁ to C₁₂ alkyl, a C₁ to C₁₂ alkoxy, C₃ to C₁₂ cycloalkyl, or a C₂ to C₁₂ alkoxyalkyl which is unsubstituted or substituted with halogen, a C₁ to C₆ alkyl, or a C₁ to C₆ haloalkyl.

7. The adhesive composition according to claim 1, wherein the at least one silane-containing polyol has a structure represented by Formula (I): 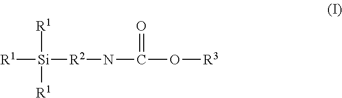
wherein each R¹ independently represents hydrogen, halogen, a C₁ to C₁₂ alkyl, a C₁ to C₁₂ alkoxy, C₃ to C₁₂ cycloalkyl, or a C₂ to C₁₂ alkoxyalkyl which is unsubstituted or substituted with halogen, C₁ to C₆ alkyl, or C₁ to C₆ haloalkyl; R² represents a linear C₁ to C₂₀ alkylene which is unsubstituted or substituted with at least one substituent selected from the group consisting of hydroxyl, halogen, C₁ to C₆ alkyl, C₁ to C₆ alkoxy, C₃ to C₆ cycloalkyl, C₂ to C₆ alkoxyalkyl, and the combinations thereof; R³ represents a linear or branched C₁ to C₁₂ alkyl which is substituted with at least two hydroxyl groups.

8. The adhesive composition according to claim 7, wherein at least two R¹ are the same or different and each represents a C₁ to C₁₂ alkoxy.

9. A cured adhesive composition prepared from the adhesive composition according to claim 1, comprising the reaction product of a curable mixture of the polyol component and the isocyanate component of the adhesive composition.

10. A method of producing a cured laminate using the adhesive composition according to claim 1, comprising:
(a) providing the adhesive composition comprising an isocyanate component and a polyol component;
(b) bringing the isocyanate component and the polyol component into contact, to form a curable mixture;
(c) applying the curable mixture on a first portion of a surface of a substrate to form a layer of the curable mixture;
(d) bringing a second portion of a surface of the same or a different substrate into contact with the layer of the curable mixture so that the layer of the curable mixture is sandwiched between the first portion and the second portion; and
(e) curing the curable mixture or allowing it to cure.

11. A cured laminate prepared by using the method of producing a cured laminate according to claim 10.

12. A cured laminate comprising a first portion of a surface of a substrate, a layer of a cured adhesive composition of claim 9, and a second portion of a surface of the same or a different substrate, wherein the layer of the cured adhesive composition is sandwiched between and in contact with the first portion and the second portion.

13. Use of a silane-containing polyol in a two-component polyurethane-based adhesive composition.
